(19) United States
(12) Patent Application Publication
(10) Pub. No.: US 2010/0239711 A1
(43) Pub. Date: Sep. 23, 2010

(54) METHOD FOR MANUFACTURING COFFEE BY SOLID STATE FERMENTATION

(76) Inventors: Pei-Jung Li, Sanwan hsiang (TW); Chao-Chia Li, Sanwan hsiang (TW); Chao-Hsiang Li, Sanwan hsiang (TW)

Correspondence Address: LEONG C LEI, PMB # 1008, 1867 YGNACIO VALLEY ROAD, WALNUT CREEK, CA, 94598, US

(21) Appl. No.: 12/408,737

(22) Filed: Mar. 23, 2009

(51) Int. Cl. A23F 5/00

(52) U.S. Cl. 426/45

(57) ABSTRACT

A method is provided for manufacturing coffee by solid state fermentation, including the following steps: depositing coffee beans in a dust-free clean container; propagating a fungus with solid state fermentation; carrying out implantation process, wherein the fungus is implanted to the coffee beans contained in the dust-free clean container with a sterile operation, the fungus being one belonging to Eumycota, including at least one selected from Basidiomycotina and Ascomycotina; and performing a fermentation process. Also provided is a formula of the solid cultivation medium used in the method, which is suitable for both large-scale and small-scale production of fungi and is applicable to most fungi to not only increase the throughput as desired, but also provide a metabolic product containing pharmacologically active ingredients.

### TECHNICAL FIELD OF THE INVENTION

The present invention relates to a solid state fermentation (SSF) cultivation method, and in particular to a method for manufacturing coffee by SSE

### DESCRIPTION OF THE PRIOR ART

In the sixth century, Ethiopian shepherds observed that goats became very energetic after consuming red coffee cherries, and they shared the chemes with monks. Everyone got energetic after consuming the cherries. Afterwards, merchants planted coffee and commercialized coffee. In the 13th century, coffee beans started to be ground for convenient consumption and in the 15th century, coffee became a common drink for Muslims. In the 17th century, coffee was spread over all the world with the propagation of European civilization.

Chung Chao, a dietician of Mackay Memorial Hospital, Taipei, Taiwan, indicated in Hospital Periodical, Volume 253, of June 2001 that coffee contains various bio-active compositions, including methylxanthines, such as caffeine, theophylline, and theobromin, flavonoid, and phenols. The major contents of coffee include caffeine, minerals, tannic acid, sugar, water, fat, protein, and fibers, among which the most commonly mentioned is caffeine. Caffeine may make the sympathetic nerve excited and thus making emotion cheered up, thinking clear and efficient, eliminating tiredness and sleepiness, and accelerating blood circulation so that human body feels warm. People use coffee to release headache and this is because caffeine may inhibit the action of phosphatase in human body, relaxing the smooth muscles of blood vessels, expanding the blood vessels, and exciting sensitive cells to release histamine acting upon central nervous system, making people feel happy and also relaxing brain blood vessels that cause headache to thereby releasing the headache. If coffee is consumed after meal, then excretion of gastric juice is enhanced and digestion is improved. Although caffeine is an alkaloid of purines, its metabolic product is not uric acid, so that gout patients are still allowed to take a proper amount of drinks containing caffeine.

A research team of Ministry of Health, Labor and Welfare, Japan, reported in Aug. 2, 2007 that studies made by National Cancer Center of Japan and Gunma University indicate that the risk of suffering colon cancer for women drinking more than three cups of coffee per day is 30% lower than those not drinking coffee and the risk can be even as lower as 56% for infiltrating colon cancers.

Animal experiments show that caffeine is effective in preventing hydroxyl compositions generated by radiation from damaging cells and protect body functions from exhaustion. Thus, caffeine provides protection against radioactivity. However, such protection cannot be just realized through drinking coffee. The radioactivity protection offered by caffeine can be used to alleviate the pain caused by radiotherapy of cancers. In addition, literatures report that one to three cups of coffer per day may be helpful in enhancing the capabilities of thinking and memorization and reducing the potential occurrence of Parkinsonism and also reducing the rate of suicide for patients of melancholia.

One hundred years ago, the Indonesians have discovered that coffee bean that has been subjected to fermentation in the gastrointestinal tract of Asia Palm Civet exhibits a very thick and aromatic taste and the Indonesians collected the droppings of Asia Palm Civet to obtain the coffee beans for making coffee. Coffee that is produced with the same model of “natural fermentation in animal gastrointestinal tract”, such as Animal Ferment coffee, is currently available in the market. An example is the Civet coffee made in Vietnam, which is believed to originate as early as the 18th century when Vietnam was governed by French colonization. The animal producing the Animal Ferment coffee is Paradoxurus hermaphroditus, commonly referred to as Asian Palm Civet. Nowadays, weasels, which are quite different from Civet in appearance, are used in Vietnam to produce the Animal Ferment coffee. Since the food of the weasels and the bacteria residing the gastrointestinal tract of the digestive system thereof are different, different flavor of Animal Ferment coffee is produced. The bacteria residing in the gastrointestinal tract of Civet are very complicated and thus, the coffee so fermented therethrough, which is often referred to as Kopi Luwak, exhibits a very complicate taste and an example is shown in FIG. 4.

Both coffee beans subjected to fermentation inside gastrointestinal tract of Asian Palm Civet and the animal ferment coffee made by Vietnamese are produced with such a purposes of making coffee dispersing aroma and providing moderate bitter and sour taste, so as to make a consumer feeing aromatic, thick, and smooth taste, alleviate initation to stomach, and also reduce the potential risk of over-consumption of caffeine.

However, the above discussed processes all adopts a model of “natural fermentation carried out with bacteria residing in the gastrointestinal tract of the digestive system of animals”. The bacteria residing in the animal digestive system is often very complicated, making it easy to generate malignant metabolic products or residuals. Further, such a fermentation process is not appealing to the general consumers due to it being seemingly un-sanitary.

### SUMMARY OF THE INVENTION

In view of the above drawbacks, an objective of the present invention is to provide a solid-state fermentation (SSF) based cultivation method for coffee that is safe, sanitary, and healthy.

Another objective of the present invention is to provide an SSF method for modifying taste of coffee beans.

To achieve the above objectives, the present invention provides a method for manufacturing coffee by solid state fermentation, comprising the following steps: depositing coffee beans in a dust-free clean container; propagating a fungus with solid state fermentation; carrying out implantation process, wherein the fungus is implanted to the coffee beans contained in the dust-free clean container with a sterile operation, the fungus being one belonging to Eumycota, including at least one selected from Basidiomycotina and Ascomycotina; and performing a fermentation process.

Compared to the known techniques, the present invention adopts solid state cultivation to replace bacterium based fermentation carried out inside gastrointestinal tract of animals, wherein marcofugi, such as Antrodia camphorata, is used to carry out fermentation within a dust-free clean environment for replacing bacterium based fermentation inside animal gastrointestinal tract. The application of the present invention makes it possible to obtain uniform and consistent quality through fermentation using a single strain of mushroom (without any malignant metabolic products or residuals resulting due to the complicated bacteria residing in the animal digestive system) and on the other hand, the taste of coffee can be modified through the clean fermentation process.

Further, the present invention adopts a solid state fermentation method for propagation of fungus and uses Antrodia camphorate, which is a macro fungus specific to Taiwan. Coffee beans that are modified with a given formula are deposited in a dust-free clean container and mushroom strain is implanted with a sterile operation for long-term fermentation in a period of 15 to 60 days without being contaminated. In this way, on the one hand, the single strain of mushroom decomposes the protein contained in the coffee beans that gives the bitter taste and changes the substance structure of the coffee beans and on the other hand, a uniform and consistent quality is obtained (without any possible malignant metabolic products or residuals resulting due to the complicated bacteria residing in the animal digestive system). With the modification induced by the fermentation process, the favor of coffee beans can be modified, making the taste richer, sweeter, and unique, whereby even only half amount of coffee is used in brewing, the same aromatic and smooth taste can be provided. This is no match by other coffee beans.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a flow chart of a method for manufacturing coffee by solid state fermentation in accordance with an embodiment of the present invention.

FIG. 2 shows a flowchart of a process for preparing solid state fermentation medium and propagation of fungus in accordance with the present invention.

FIG. 3 shows coffee beans that are manufactured with solid state fermentation in accordance with the present invention.

FIG. 4 shows the conventional Kopi Luwak (Civet coffee).

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

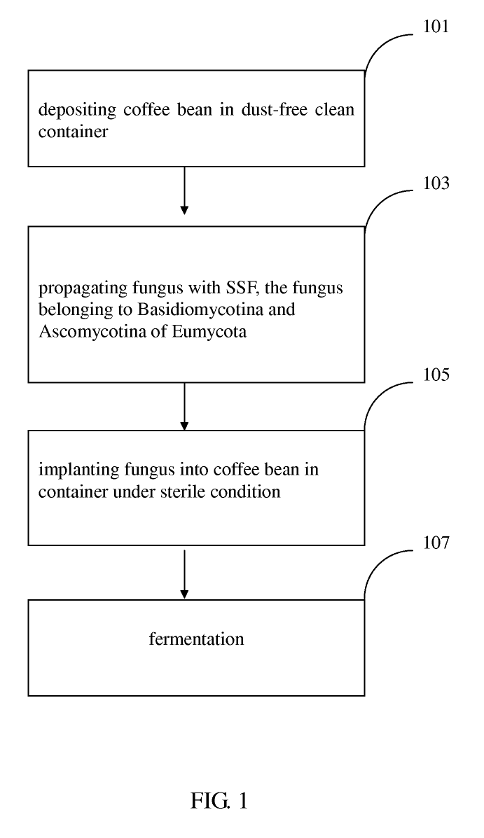

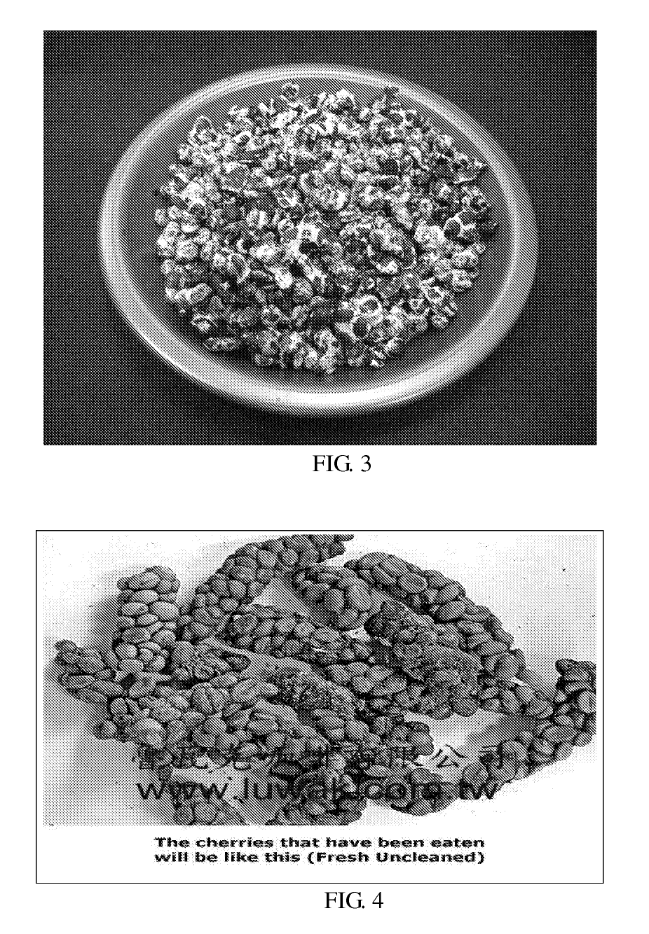

With reference to FIGS. 1-3, a method for manufacturing coffee by solid state fermentation (SSF) in accordance with an embodiment of the present invention is shown. As shown in FIG. 1, the instant embodiment of the method for manufacturing coffee by SSF comprises the following steps: Step 101, wherein coffee beans are deposited in a dust-free clean container; Step 103, wherein propagation of fungi is performed with SSF cultivation; Step 105, wherein implantation is carried out to perform a sterile operation for implanting the fungi into the coffee beans in the dust-free clean container, the fungi used being a fungi belonging to Eumycota, including at least one fungi of Basidiomycotina and Ascomycotina; and Step 107, wherein fermentation occur.

In Step 101, the coffee beans are deposited in a temperature-resistant and sealed container. The container is made of for example glass, stainless steel, temperature-resistant high density polyethylene (HDPE), and polypropylene (PP) or other types of container that are resistant to high temperature for sterilization. The coffee beans are selected from Arabica coffee, Robusta coffee, Liberica coffee, or any derivative species of coffee thereof, but are not limited thereto.

In Step 103, to propagate the fungi with SSF cultivation, mycelia of the fungi are first inoculated in a solid cultivation medium and then transferred to a fermentation cultivation medium to multiple the mycelia of the fungi. In the instant embodiment, the fungi is selected from class Basidiomycotina of Eumycota. The class Basidiomycotina include any fungi belonging to Polyporaceae and Hericiaceae, wherein the fungi selected from Basidiomycotina of Eumycota include Polyporaceae, such as Antrodia camphorata; Hericiaceae, such as Hericium erinaceum (Bull.: Fr) Pers.; Pleurotaceae, such as Pleurotus ostreatus and Lentinus edodes; Tricholomataceae, such as Airmillariella mellea, Tricholoma matsutake, and Flammulina velutipes; Pluteaceae, such as Vovariella volvacea; Agaricaceae, such as Agaricus campestris; Bolbitiaceae, such as Agrocybe cylindracea; Boletaceae, such as Boletus ornatipes; Ganodermataceae, such as Ganoderma lucidum; Hymenochaetaceae, such as Phellinus linteus; and Auriculariaceae, such as Auricularia auricula and Tremella Fuciformis. In other embodiments, the fungi used can be Ascomycotina of Eumycota, including Clavicipitaceae, wherein the fungi selected from Ascomycotina of Eumycota include Clavicipitaceae, such as Cordyceps sinensis and Cordyceps subessilis; and Xylariaceae, such as Xylaria nigripes.

Mycelia produced with Antrodia camphorata cultivated in a solid cultivation medium is thus provided, and the mycelia produced by Antrodia camphorata is transferred to a fermentation cultivation medium to multiply the fungus mycelia. The solid cultivation medium contains any one of malt extract agar (MEA), yeast extract agar (YEA), and potato dextrose agar (PDA). The fungus used is the multiplication and propagation of fungus strain of Antrodia camphorata. The solid cultivation medium contains oatmeal and a solid base thereof contains any one selected from a group consisting of rice, unpolished rice, wheat, nude wheat, barley, oat, corn, sorghum, and Coix seed. In other embodiments, when the fungus used is the multiplication and propagation of Antrodia camphorata, an oatmeal cultivation medium can be used as the fermentation cultivation medium and the fermentation cultivation medium contains a nitrogen source and a carbon source, wherein the nitrogen source includes any one selected from a group consisting of peptone, yeast powder, and malt extract and yeast peptone powder, yeast paste, yeast syrup, peanut cake powder, defatted soybean powder, wheat bran, rice bran, casein, calcium caseinate, defatted bean cake powder, the carbon source includes any one of starch, glucose, monosaccharide, polysaccharide, dextrin, maltose, saccharose, brown sugar, fructose, methyl cellulose, Mannitol, and corn powder. The solid cultivation medium has a pH value between 4.5 and 7.0.

In Step 105, multiplication of the fungi mycelia is carried out by controlling environmental light, such as a control model of 30% lighting and 70% dark. In the instant embodiment, sterilization conditions for preparing the fermentation cultivation medium are temperature 120-121° C. within a time period of 60 minutes. The fermentation medium contains 0.3-4% by weight of malt extract, 0.3-4% by weight of yeast extract, 0.2-0.5% by weight of peptone, 1-5% by weight of glucose, 30-60% by weight of water, 40-60% by weight of coffee bean.

In Step 107, the relative humidity is controlled between 40% and 70% and an incubation period of fermentation cultivation is included, which is set between 15 and 60 days. The fermentation incubation temperature is controlled between 15 and 30° C. In the instant embodiment, the fermentation incubation temperature is set between 17 and 27° C., but it is apparent that the temperature is not limited to such a range.

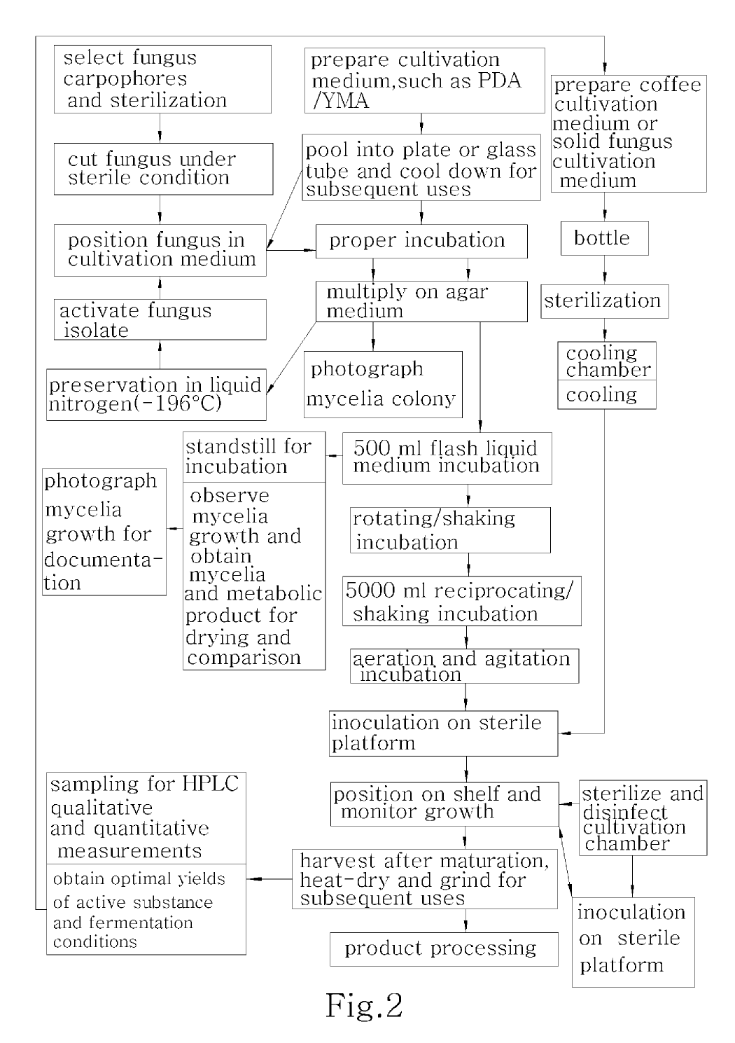

FIG. 2 shows a flow chart for preparing SSF medium and propagation of fungi. The left-hand side column of the flow chart shows a process of selection of healthy and fresh wild natural fungi or retrieval of fungi previously stored in liquid nitrogen. The central column shows three cultivation steps, including (1) solid-phase cultivation (such as slant cultivation), (2) liquid cultivation, and (3) SSF cultivation. The right-hand side column shows preparation of SSF medium. Before SSF is applied to the propagation of a fungus, certain pre-cultivation steps are to be followed. First, wild and healthy fungi of proper quality are selected and disinfected, or alternatively, fungi previously stored in liquid nitrogen are activated. The mycelia of the fungi are cut into pieces and placed into a sterilized solid cultivation medium vessel, such as a plate vessel or a slant glass test tube to carry out plate cultivation. A solid cultivation medium is then prepared and introduced into the plate or the test tube to be cooled down for subsequent use, and a proper formula of cultivation medium is deposited into the solid cultivation vessel, such as potato dextrose agar (PDA) and yeast malt agar (YMA), but not limited thereto; and it can also be yeast extract agar (YEA), malt extract agar (MEA), or peptone yeast glucose agar (PYG). The medium is disinfected at a temperature of for example 121° C. for 15 minutes and after being cooled down, the medium can be used for multiplication of fungi. The growth of the fungi can be monitored with a microscope and the mycelia colonies are documented by photography.

After the fungus mycelia have multiplied and cover the surface of the solid cultivation medium, indicating proper growth of the fungus mycelia, a block of mycelia of approximately 0.5 cm in diameter is taken and transferred to a flask which contains a liquid fermentation cultivation medium. For example, the liquid cultivation medium can be potato dextrose broth (PDB), yeast extract broth (YEB), malt extract broth (MEB), yeast malt broth (YMB), and peptone yeast glucose broth (PYGB). For example, 500 ml liquid fermentation cultivation medium is taken for the multiplication purposes. Incubation is carried out under a rotating and shaking condition with a rotational speed of 240 rpm/min to prompt the growth of mycelia for about 8 days, preferably about 5-6 days. Then, the mycelia are transferred to a large-sized flask, for example being transferred to cultivation in 5000 ml flask containing the same liquid cultivation medium and being incubated under a reciprocating shaking condition for about 3-4 days, but no more than 6 days. Afterwards, incubation under aeration/agitation is carried out for 4-5 days, wherein aeration ratio is 1:0.3-0.5 for O₂/CO₂ and the agitation speed is 200 rpm/min. Thereafter, inoculation is performed on a sterile operation table and the vessel is deposited on shelf for observation and monitoring. The growth of fungus mycelia is monitored with a microscope and documented by photography.

It is noted that in the instant embodiment, nutrients and a solid base material are heated and mixed together. After the solid base material is cooled down, calcium carbonate or gypsum (calcium sulfate dehydrate) is added to and uniformed mixed with the solid base mixture to form the SSF medium. The SSF medium is granulated and deposited in a vessel, which is then sterilized and placed in a cooling chamber for cooling. Afterwards, the fungi already prepared in the 5000 ml flask are transferred to the SSF cultivation vessel on a sterile operation table in a sterile chamber. The vessel is deposited on a shelf for observation and monitoring until maturation and harvest. However, in other embodiments, the size and specification of the vessel or container and cultivation and fermentation related conditions can be changed and what just discussed is only an example for illustration of the present invention. For example, other suitable temperature, humidity, and lighting may be maintained in the cultivation chamber, provided they are suitable for the growth of the fungi. The harvesting date of the fungi can be varied in accordance with different purposes and is not limited what discussed as examples herein.

The formula for SSF must be suitable for fungi propagation and comprises a carbon source, a nitrogen source, vitamins, and inorganic substances. Additionally, trace elements and organic substances can be added. The carbon source and the nitrogen source can be obtained from any of the previously mentioned substances. Vitamins needed include vitamin B 1, vitamin B6, and nicotinic acid, but are not limited to these three kinds. Inorganic substances include calcium sulfate and calcium carbonate, or the likes. A preferred ratio of the carbon source and the nitrogen source is about 5:1 to 25:1 by weight. During the SSF cultivation, pH value, water content, temperature, relative humidity, and lighting must be properly controlled. The pH is preferably controlled between pH 4.5 to 7. The temperature is controlled at 22±5° C. The water content is preferably set between 40-70%. The relative humidity is preferably between 60-80%.

The incubation period for SSF cultivation of fungus is normally between 20 and 60 days, and preferably between 30 and 50 days. The longer the incubation period, the greater the production of the mycelium dry weight. However, prolonged period of incubation of fungus does not guarantee that the production of metabolite or active material of fungus be proportionally increased. Due to such a discrepancy, high performance liquid chromatography (HPLC) may be employed to carry out analysis and measurement of the total nucleoside amount and the amount of ergosterol of dried mass in order to determine the optimum contents of composition and cultivation conditions and the appropriate time for harvesting the fungi. And, based on such information, preparation of coffee cultivation medium or solid fungus cultivation medium can be made. The total nucleoside content not only reflects the active life cycles of the fungus (namely, the higher the nucleoside content, the greater the replication of the fungus), but also relates to pharmacological activities.

In the present invention, the preparation of the SSF medium is selectively made by first mixing malt extract, yeast extract, peptone, glucose, water, and a solid base together and heating them to boiling to form a solid nutrition base, followed by cooling. Then, calcium carbonate or gypsum is added and mixed to form a granular SSF medium, which is deposited in a vessel and sterilized. After cooling, the prepared fungus mycelia is inoculated in the vessel and the vessel is deposited on a shelf unit maturation and harvest time. The incubation period of the mycelia propagated with SSF is determined by the total nucleoside amount and the amount of ergosterol that are obtained through analysis and monitoring with HPLC. Further, the fungus mycelia in SSF can be transferred to a fresh SSF cultivation vessel so that the propagation of the fungus mycelia can be continued.

Compared to the known techniques, the present invention adopts an SSF method for propagation of fungus and uses Antrodia camphorata, which is a macro fungus specific to Taiwan. Further, coffee beans that are modified with a given formula are deposited in a dust-free clean container and mushroom strain is implanted with a sterile operation for long-term fermentation in a period of 15 to 60 days without being contaminated.

The present invention transfers the mycelia of Antrodia camphorata that is incubated in a solid cultivation medium, such as malt extract agar (MEA), yeast extract agar (YEA), and potato dextrose agar (PDA), into a fermentation medium containing a carbon-source and nitrogen-source-included formula and having a proper pH value (oatmeal cultivation medium being used in the instant embodiment) for multiplication (such as by using the techniques that have been previously developed by the present inventor, see U.S. Pat. No. 6,558,943 B1). The oatmeal fungus strain that fully carries Antrodia camphorata mycelia or alternatively, Antrodia camphorata juice formed by uniformly pulverizing the oatmeal fungus, is directly injection into or positioned on wetted coffee beans that are contained in a container subjected to sterilization in a high temperature of 120° C. for 60 minutes. Temperature is controlled at 15-30° C. for about 15 to 60 days when the mycelia get luxuriant; and the coffee beans that are subjected to cultivation by means of fermentation may then be taken out for drying and subsequent use. In accordance with the present invention, on the one hand, the fermentation process is clean and Antrodia camphorata produces a great amount of A.B.C.K tritepenoids and other terpenes and sesquiterpenes (phytoncidere), which modifies the taste of coffee beans. Further, a single strain of mushroom is applied to effect fermentation that provides uniform and consistent quality good to human health and having pharmacologically active ingredients without any malignant metabolic products or residuals resulting due to the complicated bacteria residing in the digestive system of animals. Thus, the present invention provides a brand new emerald coffee that features both safety, sanitary, and being healthy, offering the coffer lovers all over the world another option of enjoying coffee.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing coffee by solid state fermentation, comprising the following steps:
(1) depositing coffee beans in a dust-free clean container;
(2) propagating a fungus with solid state fermentation;
(3) carrying out implantation process, wherein the fungus is implanted to the coffee beans contained in the dust-free clean container with a sterile operation, the fungus being one belonging to Eumycota, including at least one selected from Basidiomycotina and Ascomycotina; and
(4) performing a fermentation process.

2. The method according to claim 1, wherein the fungus is selected the fungi belonging to Polyporaceae and Hericiaceae of Basidiomycotina of Eumycota.

3. The method according to claim 1, wherein the fungus selected from Ascomycotina of Eumycota includes Clavicipitaceae.

4. The method according to claim 1, wherein the fungus is selected from the fungi belonging to Basidiomycotina of Eumycota, including Antrodia camphorata of Polyporaceae, Hericium erinaceum (Bull.:Fr) Pers. of Hericiaceae, Pleurotus ostreatus and Lentinus edodes of Pleurotaceae, Armillariella mellea, Tricholoma matsutake, and Flammulina velutipes of Tricholomataceae, Vovariella volvacea of Pluteaceae, Agaricus campestris of Agaricaceae, Agrocybe cylindracea of Bolbitiaceae, Boletus ornatipes of Boletaceae, Ganoderma lucidum of Ganodermataceae, Phellinus linteus of Hymenochaetaceae, Auricularia auricula and Tremella Fuciformis of Auriculariaceae.

5. The method according to claim 1, wherein the fungus is selected from the fungi belonging to Ascomycotina of Eumycota, including Cordyceps sinensis and Cordyceps subsessilis of Clavicipitaceae and Xylaria nigripes of Xylariaceae.

6. The method according to claim 1, wherein in the step of propagating fungus with solid state fermentation, mycelia of the fungus is first inoculated in a solid cultivation medium and then transferred to a fermentation cultivation medium to multiple the mycelia of the fungus.

7. The method according to claim 6, wherein Antrodia camphorata is used to produce the mycelia and the mycelia produced by Antrodia camphorata is then transferred to a fermentation cultivation medium to multiply the fungus mycelia.

8. The method according to claim 6, wherein the solid cultivation medium contains any one of malt extract agar (MEA), yeast extract agar (YEA), and potato dextrose agar (PDA).

9. The method according to claim 6, wherein the fungus is propagated by multiplication of Antrodia camphorata and the solid cultivation medium contains oatmeal and has a solid base containing any one selected from a group consisting of rice, unpolished rice, wheat, nude wheat, barley, oat, corn, sorghum, and Coix seed.

10. The method according to claim 6, wherein the fungus is propagated by multiplication of Antrodia camphorata and the fermentation cultivation medium contains an oatmeal cultivation medium, which comprises a nitrogen source and a carbon source, the nitrogen source including any one selected from a group consisting of peptone, yeast powder, and malt extract, yeast peptone powder, yeast paste, yeast syrup, peanut cake powder, defatted soybean powder, wheat bran, rice bran, casein, calcium caseinate, defatted bean cake powder, the carbon source including any one of starch, glucose, monosaccharide, polysaccharide, dextrin, maltose, saccharose, brown sugar, fructose, methyl cellulose, Mannitol, and corn powder.

11. The method according to claim 6, wherein the solid cultivation medium has a pH value between 4.5 and 7.0.

12. The method according to claim 6, wherein the step of propagating fungus with solid state fermentation is carried out by controlling environmental light in such a way that a control model of 30% lighting and 70% dark is realize.

13. The method according to claim 6, wherein fermentation cultivation medium is prepared under sterilization conditions of temperature 120-121° C. within a time period of 60 minutes.

14. The method according to claim 6, wherein the fermentation medium contains 0.3-4% by weight of malt extract, 0.3-4% by weight of yeast extract, 0.2-0.5% by weight of peptone, 1-5% by weight of glucose, 30-60% by weight of water, and 40-60% by weight of coffee beans.

15. The method according to claim 1, wherein in the step of performing fermentation process, fermentation incubation temperature is set between 15 and 30° C.

16. The method according to claim 1, wherein in the step of performing fermentation process, fermentation incubation temperature is set between 17 and 27° C.

17. The method according to claim 1, wherein in the step of performing fermentation process, relative humidity is controlled between 40% and 70% and an incubation period of fermentation cultivation is included, which is set between 15 and 60 days.

18. The method according to claim 1, wherein the coffee beans are selected from any one of Arabica coffee, Robusta coffee, and Liberica coffee, and derivative species thereof.

19. The method according to claim 1, wherein the container is made of a material selected from the group consisting of glass, stainless steel, temperature-resistant high density polyethylene, and polypropylene.

20. The method according to claim 1, wherein the container is a temperature-resistant and sealed container.
